(19) United States
(12) Patent Application Publication
(10) Pub. No.: US 2006/0049225 A1
(43) Pub. Date: Mar. 9, 2006

(54) Vehicle article carrier

(76) Inventors: Karl Blankenburg, Warren, MI (US); Mitch Marchi, Bloomfield Hills, MI (US)

Correspondence Address: WILLIAM M HANLON, JR;YOUNG & BASILE, PC, 3001 WEST BIG BEAVER ROAD, SUITE 624, TROY, MI, 48084-3107, US

(21) Appl. No.: 10/937,175

(22) Filed: Sep. 9, 2004

(51) Int. Cl. B60R 9/00

(52) U.S. Cl. 224/325; 224/321

(57) ABSTRACT

A vehicle article carrier having at least one lateral cross rail selectively positionable along a pair of spaced side rails. A drive is coupled to rotatable shaft in each side rail. Cleats are connected to opposite ends of the cross rail and coupled to the rotatable shaft in each side rail. In one aspect, first and second couplers are fixed to the rotatable shafts. A flexible cross shaft extends between the couplers. A manual crank is attachable to either of the couplers for effecting movement of the cross shaft. Alternately, an electric motor may be coupled to the cross shaft to effect rotation of the rotatable shafts and the cross rail. Alternately, the cross shaft and couplers are replaced by separate motors coupled to the rotatable shaft in each side rail. Alternately, removable covers are fixed over the side rails and end caps.

### BACKGROUND

The present invention relates to article carriers for vehicles.

A variety of different article or cargo carriers have been devised to transport articles or cargo on the exterior surfaces of vehicles, such as on the roof or trunk of an automotive vehicle. Such carriers typically include a pair of side rails fixed to and extending longitudinally of the vehicle exterior panel. At least a pair of cross rails are connected to and extend laterally between the side rails for supporting a load on the article carrier and to provide convenient tie-down of the load or cargo. Such cross rails are typically supported above the vehicle exterior surface by stanchions mounted on opposite ends of each cross rail which slidably engage the side rails.

In order to facilitate the transport of different sized loads or cargo, slidable and even removable cross rails have been provided in vehicle article carriers. At least one and, frequently, all of the cross rails on a vehicle article carrier are provided with stanchions which slide within or on a side rail and include a releasable latch which engages the side rail in one of a number of discrete positions or at any variably selected position along the length of the side rail. Such latch mechanisms are mounted in each stanchion and include rotatable knobs, cam levers, clamps and pivotal hooks which releasably engage a side rail.

In order to reposition a movable cross rail, after the latch has been released, a user will grasp the cross rail, typically adjacent one end or stanchion, and then forcibly urge the cross rail longitudinally along the vehicle roof to the desired position before re-engaging the latch or latches. During such movement, it is difficult for a single person to move the cross rail squarely along the side rails when only exerting force on the cross rail from one side of the vehicle which impedes the smooth sliding movement of the cross rail.

In an attempt to elevate this problem a prior vehicle article carrier had a movable drive member mounted in each side rail and coupled by a shuttle cleat to one end of a movable cross rail. An electric drive motor or motors were operable to longitudinally move the drive members in both side rails to effect repositioning of the cross rail under power. The same article carrier had a optional manual crank which could be inserted into a drive gear at one end of either drive member for longitudinally moving both drive members upon rotation of the manual crank inserted into one drive gear on one side of the article carrier. This enabled the cross rail to be repositioned along the length of the article carrier from either side of the vehicle.

Despite the advantages of the above described repositionable vehicle article carrier, it is believed that further inmprovements could be made to improve the article carrier operation, reduce cost, and simplify assembly.

### SUMMARY

The present invention is a vehicle article carrier which provides adjustable positioning of a moveable cross rail along a pair of spaced side rails while maintaining the movable cross rail in substantial perpendicularity to the side rails.

The vehicle article carrier includes a pair of spaced side rails mounted on and extending longitudinally along a vehicle body surface. A cross rail is slidably mounted on and extends between the side rails and is movably positionable along the side rails. A rotatable shaft is mounted in both side rails. Drive means are coupled to the rotatable shaft for longitudinally adjusting the position of the movable cross rail along the side rails while maintaining the movable cross rail substantially perpendicular to the side rails in response to rotation of the rotatable shafts.

A shuttle cleat is slidably mounted within each side rail. The rotatable shaft in each side rail is coupled to the shuttle cleat for longitudinal movement of the shuttle cleat upon rotation of the shaft. The shuttle cleat is connected to one end of the moveable cross rail such that the cross rail moves longitudinally along the side rail with movement of both shuttle cleats.

The drive means for rotating each shaft in the side rails includes, in one aspect of the invention, a coupling means associated with each side rail. Each coupling means has a first rotatable shaft engagable with one rotatable shaft in one of the side rails, a second rotatable shaft coupled by a transverse shaft connected to another coupling means and the rotatable shaft on the opposite side rail.

A manually operated crank can be coupled to an end portion of the second shaft of either coupling means. Rotation of the crank effects rotation of the transverse shaft and the other coupling means which results in simultaneous and equal rotation of the shafts in each side rail to effect repositioning of the ends of the cross rail along the longitudinal extent of the article carrier.

In another aspect, the drive means includes an electric motor having two bidirectional rotatable output shafts. In this aspect, the electric motor is mounted in the fixed cross rail. The drive shafts, typically flexible drive shafts, are connected between the output shafts of the motor and the second shafts of the coupling means such that activation of the motor output shafts in either direction results in equal and simultaneous rotation of the rotatable shafts in each of the side rails to effect repositioning of the movable cross rail.

In another aspect, the drive means includes a pair of electric motors, each having a bidirectional rotatable output shaft coupled to one of the rotatable shafts in one of the side rails. Typically, each drive motor is mounted on an end cap attached to one end of each side rail. A control means receives encoded position signals from each motor and regulates the actuation of each motor so that the motors rotate at essentially the same rotational speed and the same rotational amount to effect even transitioning of the cross rail along the side rails.

In yet another aspect, which is usable with any of the different drive means of the present invention, outer covers are affixed to each of the side rails and may include a portion of end caps attached to one or both ends of each side rail. The outer covers are removably attached to the side rails to enable their interchangability so that the vehicle article carrier of the present invention can be used on many different vehicles. The outer covers may have aesthetic and/or aerodynamic shapes and may be formed of different materials, such as metal and plastic as well as being provided in different colors and finishes, without requiring modification to the side rails or cross rails.

The vehicle article carrier of the present invention provides adjustable repositioning of a movable cross rail along a pair of the side rails while maintaining the ends of the movable cross rail substantially perpendicular to the side rails for easy sliding movement of the movable cross rail. Rotation coupling means or gear boxes are coupled to each rotatable shaft in the side rails and to the cross shaft that extends between the coupling means for effecting simultaneous and equal movement of the rotatable shafts and side rails upon rotation of the coupling means and/or cross shaft. A manual crank connected to one coupling means on one side of the vehicle causes rotation of both shafts to reposition the cross rails from either side of the vehicle.

### BRIEF DESCRIPTION OF THE DRAWING

The various features, advantages and other uses of the present invention will become more apparent by referring to the following detailed description and drawing in which:

FIG. 1 is a perspective view of an article carrier constructed in accordance with one aspect of the present invention;

FIG. 2 is a perspective view of one of the side rails of the article carrier shown in FIG. 1;

FIG. 3 is a partial, perspective view showing the mounting of the fixed cross rail to an end cap on one of the side rails as shown in FIG. 1;

FIG. 4 is an enlarged, partial, perspective view showing the mounting of the movable cross rail to one of the side rails;

FIG. 5 is a enlarged, perspective view of one end of the cross rails;

FIG. 6 is a cross-sectional view, generally taken along line 6-6 in FIG. 1;

FIG. 7 is a perspective view, with the outer cover removed, showing the connection of the drive means, shuttle cleat, stanchion and movable cross rail;

FIG. 8 is a perspective view showing the shuttle cleat and the stanchion depicted in FIG. 7;

FIG. 9 is an lateral cross-sectional view showing another aspect of the drive means of the present invention;

FIG. 10 is a perspective view showing the drive means and one of the side rails;

FIG. 11 is a enlarged, perspective view of one of the drive couplers employed in several aspects of the drive means of the present invention;

FIG. 12 is a exploded, perspective view showing the base and upper cover of one of the end caps shown in FIG. 1;

FIG. 13 is a perspective view, with the upper cover removed, showing the interconnect of the fixed cross rail, drive means and one of the side rails;

FIG. 14 is perspective view of a flex shaft employed in one aspect of the drive means of this present invention;

FIG. 15 is a cross sectional view generally taken along the line 15-15 in FIG. 1;

FIG. 16 is a cross sectional view generally taken along the line 16-16 in FIG. 1;

FIG. 17 is partial, perspective view showing the inside of one of the outer side rail covers of the present invention;

FIG. 18A is an enlarged, perspective view of one mounting clip used to attach the end cap to the base cap;

FIG. 18B is an enlarged, perspective view of another mounting clip used to attach the outer covers to the side rails;

FIG. 19 is a cross sectional view generally taken along the line 19-19 in FIG. 1;

FIG. 20 is a cross sectional view generally taken along the line 20-20 in FIG. 1;

FIG. 21 is a cross sectional view generally taken along the line 21-21 in FIG. 1;

FIG. 22 is a cross sectional view generally taken along the line 22-22 in FIG. 1;

FIG. 23 is a cross sectional view generally taken along the line 23-23 in FIG. 1;

FIG. 24 is an enlarged, perspective view showing the side rail, end cap, stanchion and one end of the movable cross rail with the outer cover mounted over the side rail;

FIG. 25 is a bottom, perspective view of the end cap shown in FIG. 24;

FIGS. 26, 27A, and 27B are circuit diagrams of control circuitry for the drive means according to another aspect of the present invention;

FIG. 28 is a perspective view, with the upper end cap cover removed showing the mounting of the drive motor in one end cap according to another aspect of the present invention;

FIG. 29 is a perspective view of the lower base of the end cap shown in FIG. 28; and

FIG. 30 is a cross-sectional view generally taken along 30-30 in FIG. 1.

### DETAILED DESCRIPTION

Referring now to the drawing there are illustrated various aspects of an article carrier 10 which is adapted for carrying articles or cargo on an exterior body panel of a vehicle.

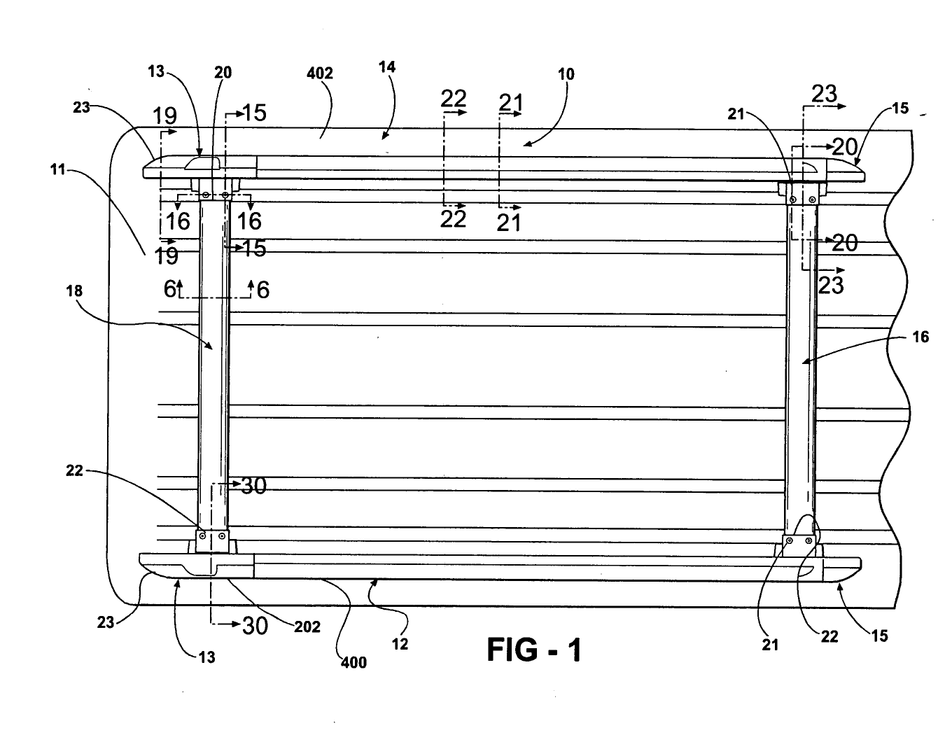

As shown in FIG. 1, the article carrier 10 is mounted on a substantially horizontally extending vehicle exterior surface 11, such as a roof panel, of a vehicle. Alternately, the article carrier 10 could be mounted on a trunk of an automobile. Such exterior surfaces 11 are substantially horizontal in orientation and generally planar in shape, except that such body panels may have a slight bow from a longitudinal center line to the outer side edges thereof.

In general, the article carrier 10 includes a pair of side rails denoted generally by reference numbers 12 and 14 which are laterally spaced on the exterior body panel 11 and extend longitudinally along the length of the exterior body panel 11. The side rails 12 and 14, which are substantially identical, although typically formed as mirror images of each other, may be formed of any suitable material for carrying articles, such as metal, plastic and combinations thereof The side rails 12 and 14 are fixed to the vehicle exterior surface 11 by suitable means, such as fasteners, adhesive, etc., not shown. Further, the side rails 12 and 14 may have any suitable shape, with the shape described and illustrated herein being by way of example only. Such shapes may provide aerodynamic qualities as well as serving an aesthetic purpose.

By example only, as shown in FIG. 21, the side rails 12 and 14 may have a multi-ribbed cross-section along their longitudinal length. The side rails 12 and 14 include an outer flange 12A having apertures for receiving fasteners to secure the side rails 12 and 14 to the vehicle exterior surface 11, an arcuate outer surface 12B which smoothly extends from the outer flange 12A to an upper flange 12C. The flange 12C also includes apertures for securing an outer cover, described hereafter, to the side rails 12 and 14. A substantially versicle wall 12D extends from a T-section 12D interiorly of the outer wall 12B and the upper flange 12C.

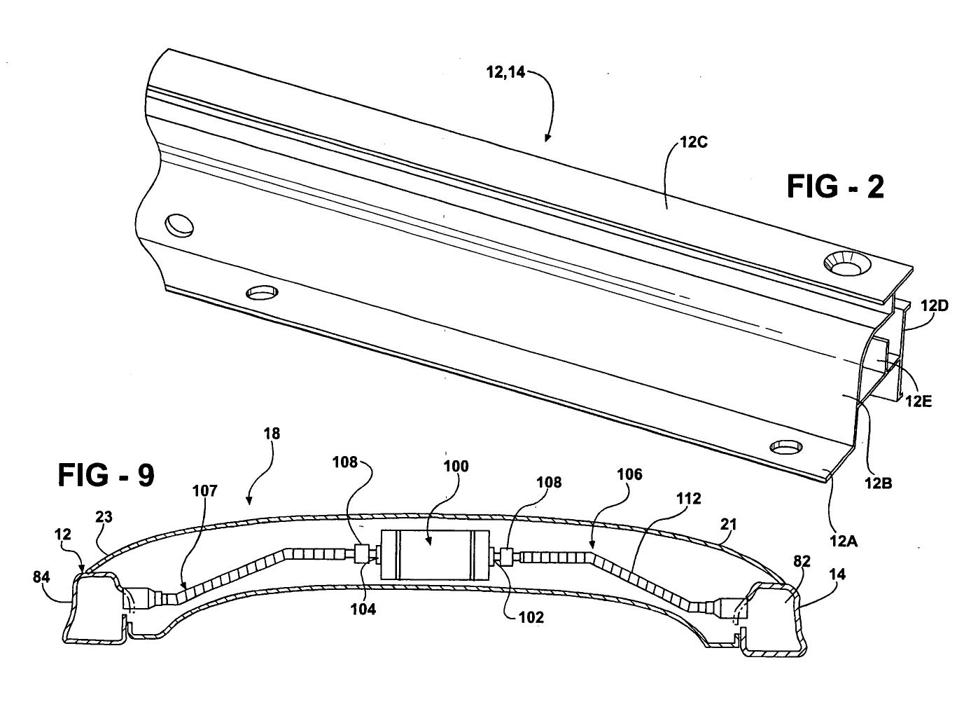

Although not shown in FIG. 2, a seal member, such as a gasket, may be interposed between the lower flange 12A and the vehicle surface 11.

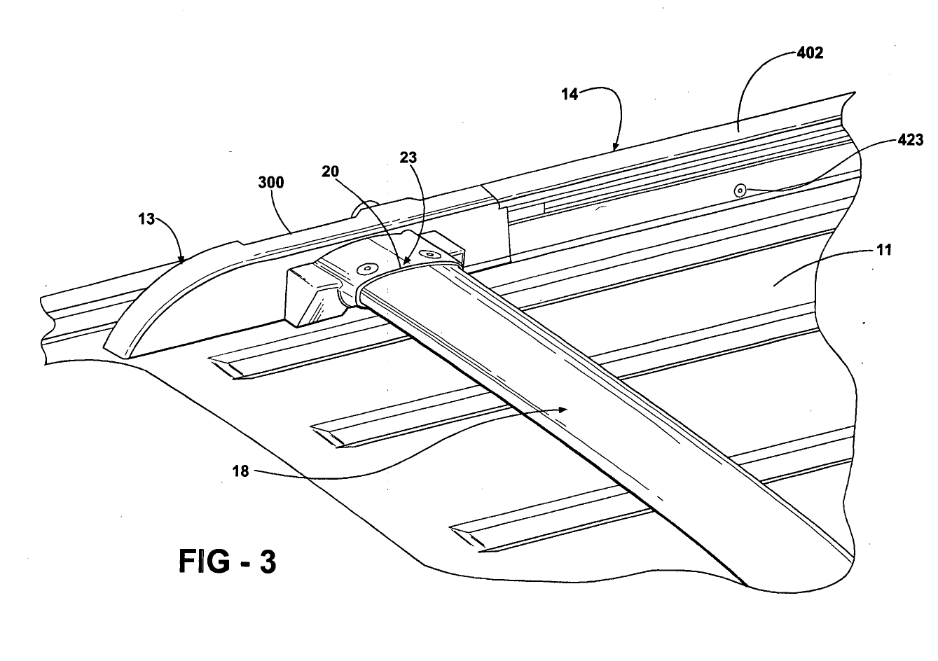

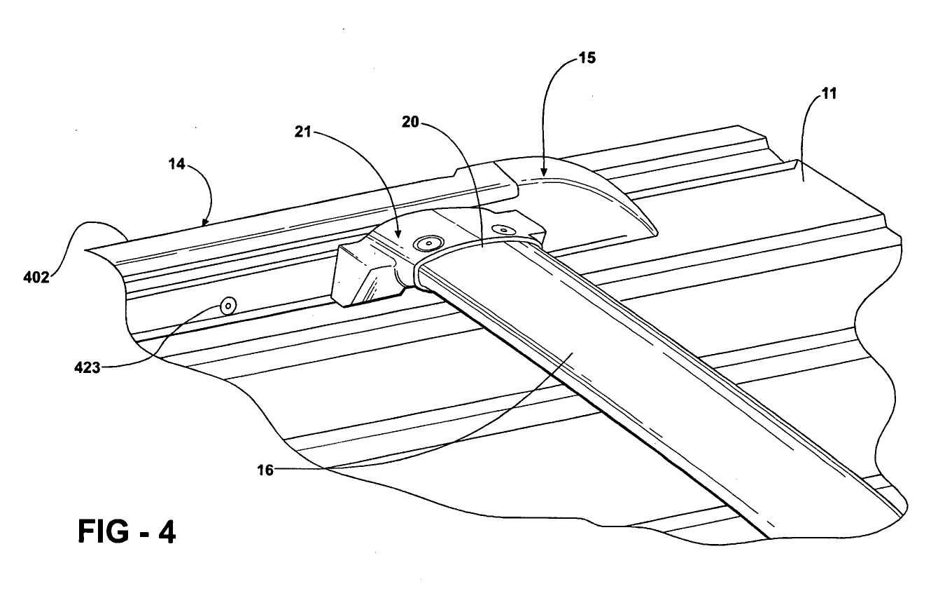

As shown in FIGS. 3, 4, and 7, end caps 13 and 15 are mounted on opposite ends of each side rail 12 and 14, respectively, to close the ends of the side rails 12 and 14. Each of the side rails 12 and 14 may be formed of two sections, each integrally formed with one of the end caps 13 and 15. Alternately, the end caps 13 and 15 may be joined to opposite ends of a single piece side rail 12 and 14 by interfitting tongue and groove connections. Suitable fasteners, adhesives, etc., not shown, may also be employed to fixedly interconnect the side rails 12 and 14 to the end caps 13 and 15.

The article carrier 10 includes at least two cross rails 16 and 18, at least one of which is movable longitudinally along the side rails 12 and 14. As shown in FIG. 1 for example, the cross rail 16 is movable longitudinally along the side rails 12 and 14; while the cross rail 18 is stationarily mounted to the side rails 12 and 14.

The cross rails 16 and 18 extend laterally between the side rails 12 and 14 and are formed with any exterior shape, such as, for example, a shape providing aerodynamic and/or aesthetic qualities. Further, the cross rails 16 and 18 may be formed of any suitable metal, plastic, or combinations thereof, and may be hollow or solid, or combinations thereof, as desired.

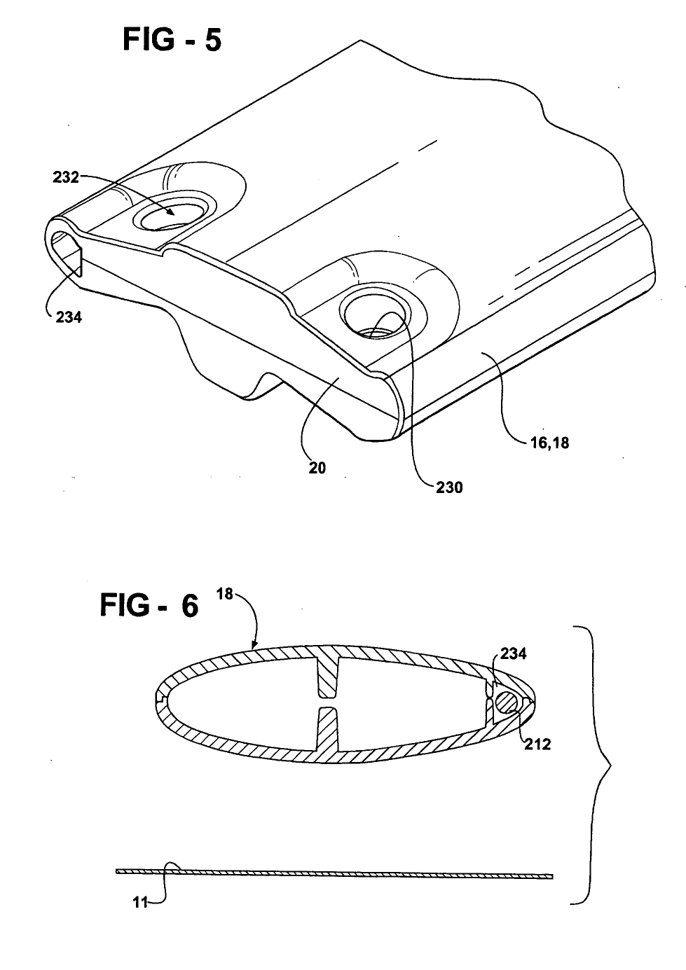

Each of the cross rails 16 and 18 are formed, by example only, of upper and lower members which are joined together by fasteners, adhesive, etc., as shown in FIGS. 5 and 6 to define a unitary body having a substantially hollow interior cavity extending between opposed lateral ends 20 and 22. As shown in FIG. 5, each end, such as end 20, has, by example only, at least one or a pair of throughbores 230 and 232.

A longitudinally extending bore 234 is also formed in each cross rail 16 and 18, the purposes which will become more apparent hereafter.

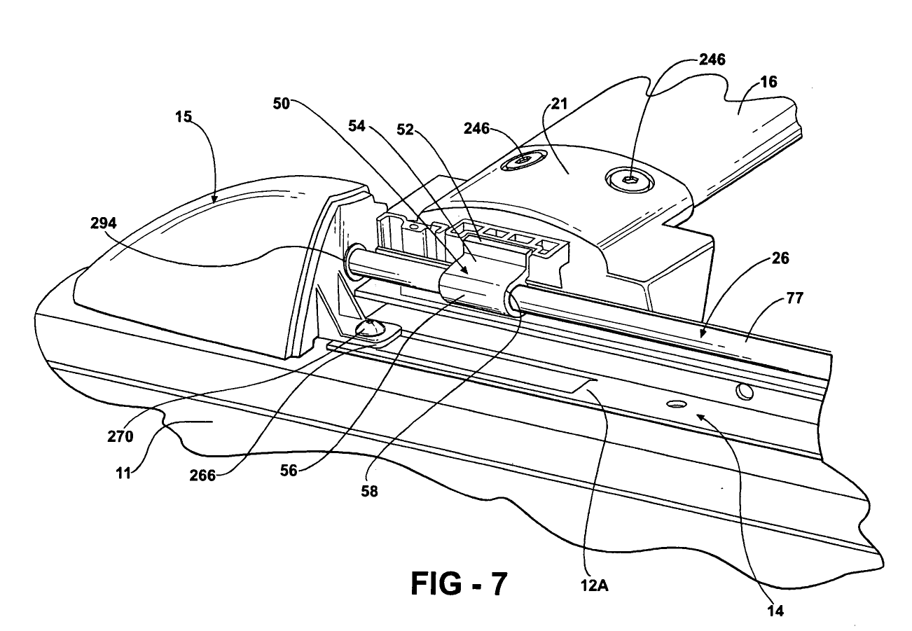

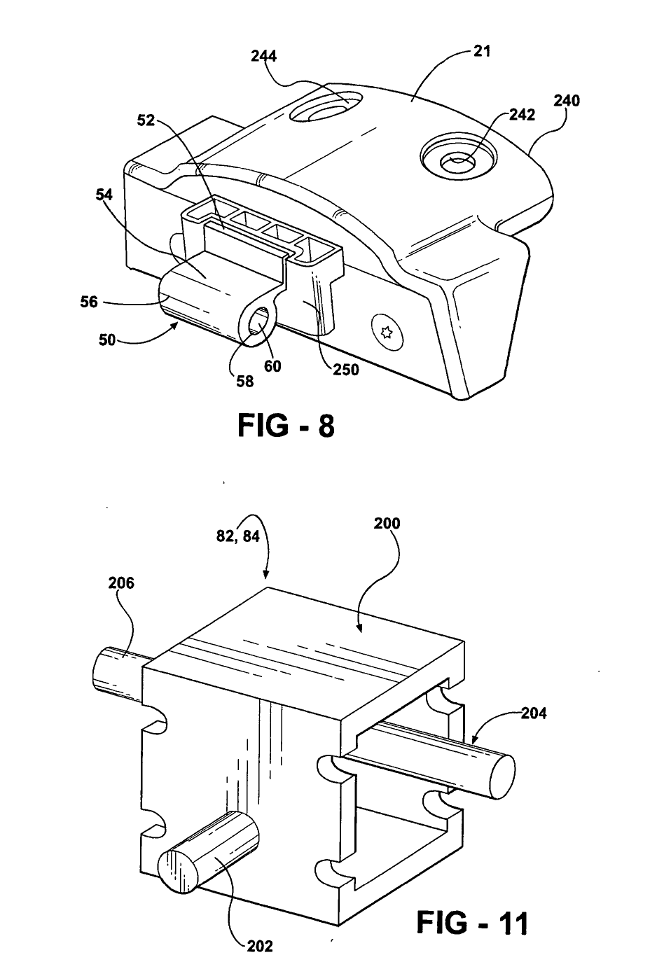

Separate stanchions 21, shown in FIGS. 7 and 8, are attached to each end 20 and 22 of the cross rail 16. Separate stanchions 23 are attached to each end 20 and 22 of the cross rail 18. The stanchions 21 are substantially identical to each other. Likewise, the stanchions 23 are substantially identical to each other, but provided in mirror images. The stanchions 21 and 23 serve to slidably connect the cross rails 16 and 18 to the side rails 12 and 14 as well as to support the cross rail 16, typically above the vehicle exterior surface 11.

The stanchions 23 may be integrally formed as part of the end caps 13. Alternately, the stanchions 21 and 23 for the cross rails 16 and 18 can be separate elements mounted on the side rails 12 and 14 or end caps 13 and 15 and attached to opposite ends of the cross rails 16 and 18. As shown in FIGS. 7 and 8, the stanchions 21 are, by example only, formed of two complementary members which are fixed together to define a unitary body. The stanchion 21 has an open end 240 which slidably receives a complementary shaped end of the cross rail 16 shown in FIG. 7. The bores 230 and 232 in the cross rail 16 are aligned with bores 242 and 244 in the stanchion 21 and receive fasteners 246 to secure the cross rail 16 to each of the stanchions 21.

The stanchions 21 includes a holder 250, see FIGS. 7, 8, and 23, which receives supports a shuttle cleat 50. The shuttle cleat 50, shown in detail in FIGS. 7, 8, and 23, is slidably mounted in each side rail 12 and 14. The shuttle cleat 50 has hanger portion 52 engaged with the holder 250. An arm 54 extends from the hangar portion 52. The arm 54 extends through an opening in each side rail 12 and 14 into the interior of each side rail 12 and 14, as shown in FIG. 23, to allow sliding movement of the shuttle cleat 50 and the attached cross rail 16 longitudinally along each side rail 12 and 14 as described hereafter.

The arm 54 transitions into a cylindrical end 56 which is disposed within the channel or interior opening within each side rail 12 and 14. A bore 58 extends through the cylindrical portion 56. If the shuttle cleat 50 is formed of a metallic or other high strength material, the interior of the bore 58 may be threaded to receive a drive shaft, as described hereafter. Alternately, where the shuttle cleat 50 is formed of a plastic material, the shuttle cleat 50 maybe threaded or contain an internally threaded, hollow metallic insert 60 is fixedly mounted, such as by a press fit, in the cylindrical portion 56. The insert 60 provides a threading,connection to the threaded drive shaft, again as described hereafter.

A drive means is provided for moving the cross rail 16 longitudinally along the side rails 12 and 14. The drive means includes a drive member denoted generally by reference number 76 in the form of a threaded shaft 77. The threads maybe a helical or Acme-type thread. The drive member 76 engages the metal insert 60 or the threads in the cylindrical portion 56 on the shuttle cleat 50. The shaft 77 of the drive member 76 can be a rigid or flexible.

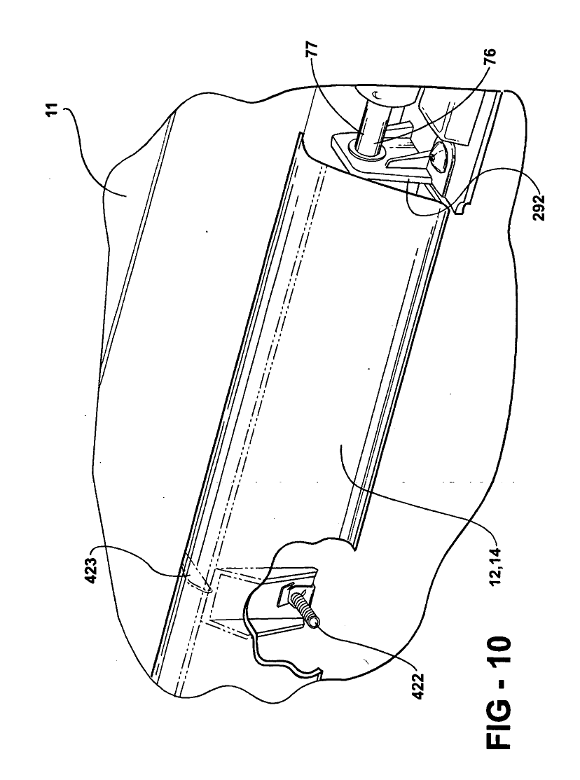

The shaft 77 is supported for rotation, but not axial movement in the side rails 12 and 14 and the end caps 13 and 15 as shown in FIGS. 7 and 10. This causes the shuttle cleat 50 and the attached cross rail 16 to traverse longitudinally along the side rails 12 and 14 upon rotation of the drive shafts 77 in each side rail 12 and 14.

Referring briefly to FIG. 25, one end of each drive member 76 passes through an aperture 260 in the end cap 15 and abuts a stop 262 carried internally within the end cap 15. Shown in FIG. 7, a bearing means, such a NYLINER™ bearing 264, may be mounted in end cap 15 to support one end of the drive member 76 and disposed adjacent an outer end of the end cap 15.

As shown in FIGS. 7 and 25, each end cap 15 has a flange 266 extending from one end with an aperture 268 which overlays one end of the lower flange 12a of the side rails 12 and 14. The aperture 268 is alignable with one of the apertures in the flange 12A for receiving a fastener 270 to secure both the end cap 15 to the side rail 12 or 14 and the side rail 12 or 14 to the vehicle surface 11.

Since the shuttle cleat 50 is fixedly connected to the stanchion 21 on the movable cross rail 16 and threadingly coupled to the drive member 76, bi-directional movement of the drive member 76, as described hereafter, results in bi-directional sliding movement of the shuttle cleat 50 in each side rail 12 and 14 thereby causing sliding movement of the movable cross rail 16.

Referring now to FIG. 9, the drive means, in one aspect of the invention, includes an electric drive motor 100 which is fixedly mounted in the stationary cross rail 18. It will be understood that the drive motor 100 could also be mounted in other locations; i.e., in one end cap 13, for example, as long as suitable connections are provided to couple the motor output shaft to each of the rotatable drive shafts 76.

The drive motor 100 may be any suitable motor, such as a fractional horse power electric motor. The drive motor 100 has at least one and preferably a pair of oppositely extending, rotatable output shafts 102 and 104. Suitable control wires, not shown, extend from the motor 100 to a power source, such as the vehicle battery, as well as to a control switch having multiple positions, i.e., forward, reverse, and/or “off”.

The control switch reverses the polarity of electric power supplied to the motor 100 thereby enabling the output shafts 102 and 104 to rotate in unison in one of two opposed directions to reposition the movable cross rail 16 to a selected longitudinal position on the vehicle surface 11 with respect to the stationary cross rail 18.

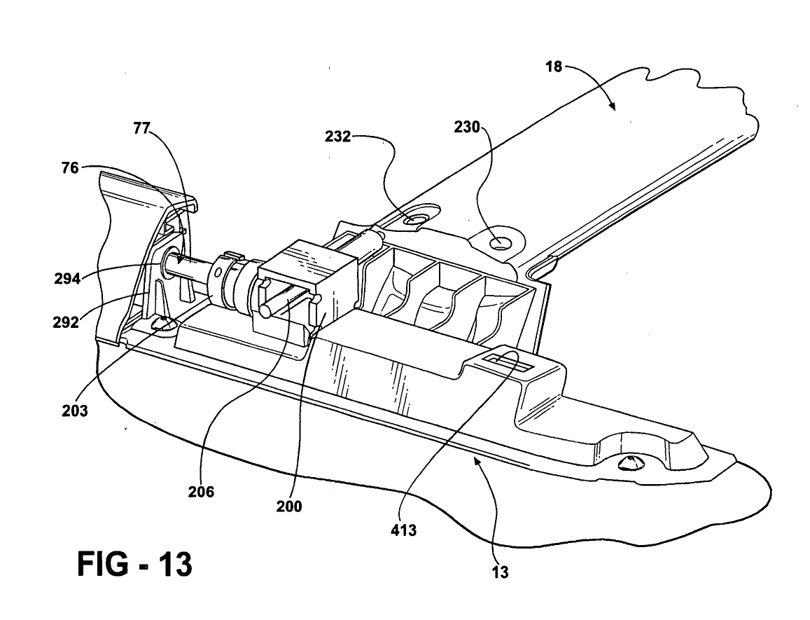

A flexible, rotatable connector or shaft 106 connects the output shaft 102 to a coupling means 82 in the side rail 12. A similar flexible, rotatable connector or shaft 107 connects the output shaft 104 to another coupling means 84 in the opposed side rail 14 as shown in FIGS. 9 and 13. Any flexible shaft 106 and 107 may be employed which is capable of transmitting rotation of the motor output shaft 102 or 104 to the associated coupling means 82 or 84 despite any offset between the rotational axes of the output shafts 102 and 104 of the motor 100 and the coupling means 82 and 84.

By way of example only, the shafts 106 and 107 are each in the form of a flexible shaft. Such a flexible shaft has an end fitting 108 which engages the rotatable output shaft 102 or 104 of the motor 100 and is fixed in place by means of a set screw, for example. At the other end of the shafts 106 and 107, a fitting having a D or square shaped bore, for example, extends into engagement with a correspondingly formed D, hex or square shaped component in the coupling means 82 or 84 to interconnect the flexible shaft 106 to 107 to the coupling means 82 or 84. The flexible shafts 106 and 107 may have an outer housing 112 which surrounds an internally disposed, flexible shaft or cable, not shown, extending between the end fittings 108.

In operation, when the motor control switch is activated, electric power is supplied to the motor 100 causing the output shafts 102 and 104 to simultaneously rotate in the same direction. Such rotation is transmitted by the flexible connectors or shafts 106 and 107 to the coupling means 82 and 84 in the side rails 12 and 14.

The coupling means 82 and 84, in one aspect of the present invention shown in FIGS. 10, 11, 13, and 15, includes a housing 200 which supports a plurality of rotatable shafts including a first shaft 202 and a second shaft 204.

The coupling means 82 and 84 may be a right angle helical gear drive, such as a gear drive, model RA-203 by Torque Transmission. Such a drive has helical gears, not shown, mounted on adjacent portions of the shafts 202 and 204 to transmit rotation between the shafts 202 and 204. The shafts 202 and 204 are rotatably mounted in the housing 200 on bearings not shown. As shown in FIGS. 11 and 13, the shaft 204, which is fixedly connected to one of the end connectors on the shafts 106 and 107 driven by the drive motor 100, has an outer end portion 206 which projects exteriorly of the housing 200, the purpose of which will become more apparent hereafter.

The first shaft 202 is coupled by a sleeve 203 to one drive member 76. The sleeve 203 has end fittings engagable with the drive member 76 and the first shaft 202. A screw tightenable collar forms one of the fittings to fix the sleeve 203 to the first shaft 202.

In a powered sequence of operation, rotation of the flexible connectors 106 and 107 is transmitted to the coupling means 82 and 84. This results in simultaneous and like direction rotation of the drive members 76 in the side rails 12 and 14. Since each drive member 76 is fixedly secured to one of the shuttle cleats 50, as described above, each shuttle cleat 50 moves with rotation of the drive member 76 thereby resulting in simultaneous driving movement of both ends 20 and 22 of the cross rail 16. Since the drive members 76 and the connectors 106, 107 are moved simultaneously, both ends 20 and 22 of the movable cross rail 16 likewise move in unison thereby maintaining the cross rail 16 substantially perpendicular to the side rails 12 and 14 during movement. The control switch to the motor 100 is released when the movable cross rail 16 has reached the desired position with respect to the fixed cross rail 18.

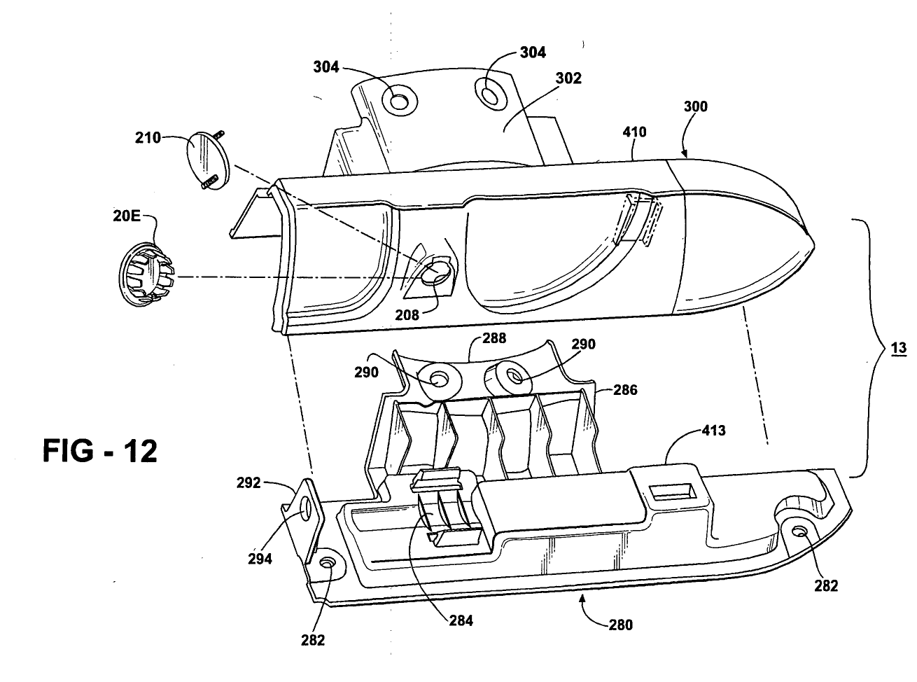

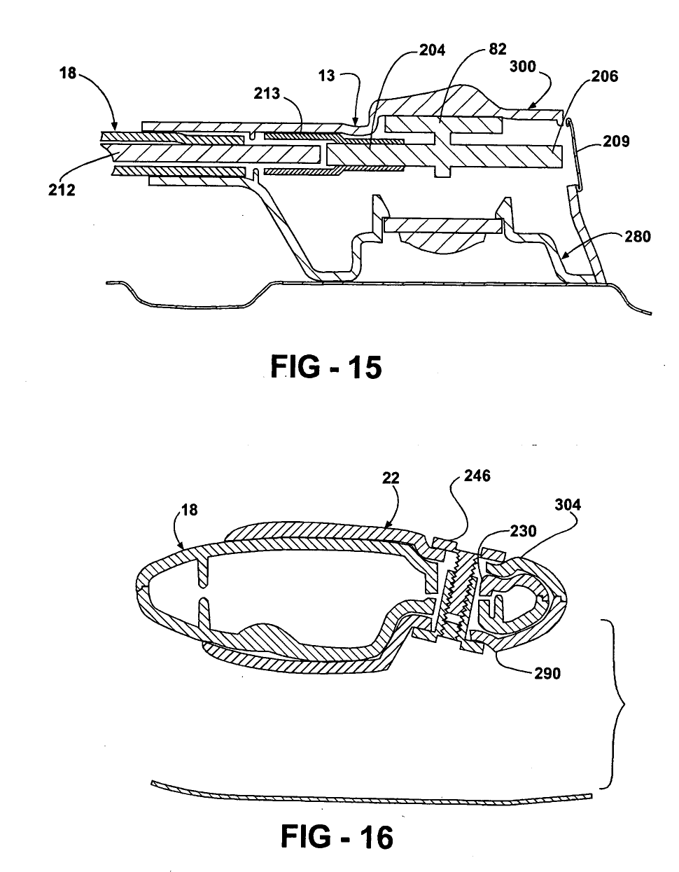

As seen in FIG. 15, the shaft end portion 206 is alignable with an opening 208 in the stanchion 13 to provide access to the shaft end 206 by an optional manual hand crank 210, shown in FIG. 12 and described hereafter.

In another aspect of the present invention, the drive means as shown in FIG. 9 which includes an electric drive motor 100 and two rotatable output shafts 106 and 107, is replaced by one rotatable shaft 212 (see FIG. 6) which connects the two coupling means 82 and 84. The article carrier 10 is, in this aspect, operative in a fully manual mode by the hand crank 210.

An optional plug 209 with spring fingers as shown in FIGS. 12 and 15, releasably closes the aperture 209 when the manual crank 210 is not attached to shaft 206 in either coupler 82 or 84. The plug 209 is removed to enable attachment of the crank 210 to the shaft 206 in either coupler 82 or 84.

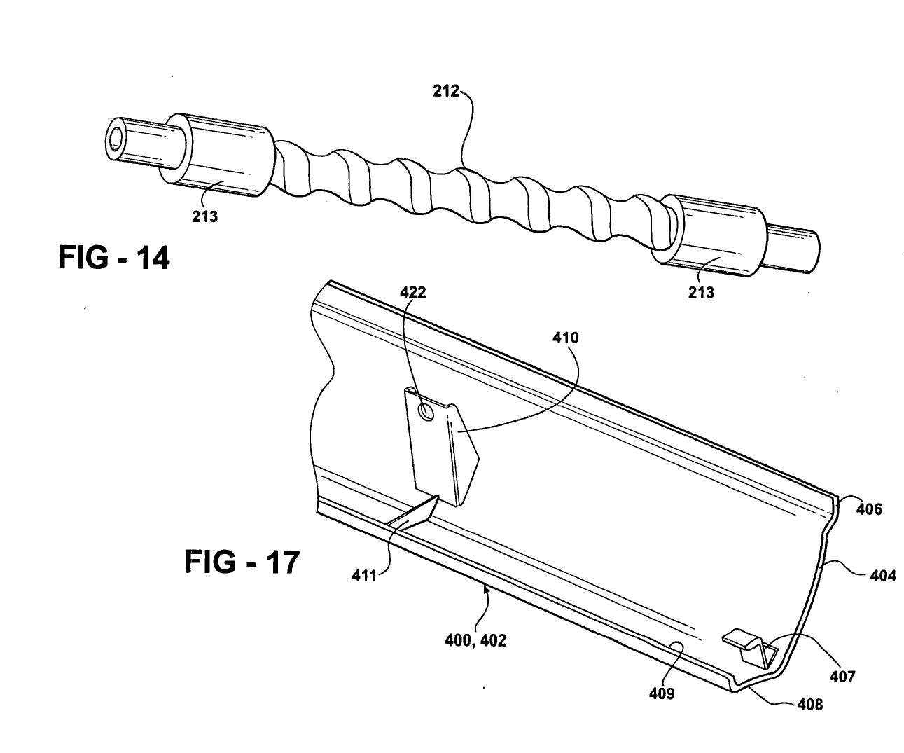

In a manual operation using a hand crank 210, the flexible connectors 106 and 107 comprise a single rotatable shaft, such as a flex shaft 212, shown in FIGS. 14 and 15. The shaft 212 many have a smooth or outer surface, as shown in FIG. 14 covered by an exterior sheath. The ends of the flex shaft 212 are coupled by connectors 213 to the second shafts 204 in each of the coupling means 82 and 84.

Attachment of the hand crank 210 to the second shaft 206 in either coupling means 82 and 84 provides simultaneous rotation of the flex shaft 212 and the drive members 76 in each side rail 12 and 14 to cause simultaneous and identical movement of the ends of the cross rail 16 along the longitudinal extent of the side rails 12 and 14.

As shown in FIG. 12, each stanchion 13 disposed on opposite ends 20 and 22 of the fixed cross rail 18 includes a base 280 which is fixedly mounted to the vehicle exterior surface 11 by means of fasteners extendable through apertures 282 in the base 280.

A support 284 is formed in the base 280 for non-moveably receiving the housing 200 of the coupling means 82 or 84. A generally L-shaped flange portion 286 projects from the base 280 and terminates in an upper end 288 having one or more throughbores 290.

An upper cover 300 having any aesthetic and/or aerodynamic exterior shape is engagable with the base 280 and secured thereto by fasteners. The upper cover 300 includes the aforementioned optional aperture 208 for mounting of the optional manual crank 210 to the shaft end 206 for manual movement of the movable cross rail 16 as described above.

The upper cover 300 has a side flange 302 containing bores 304 alignable with the bores 290 in the base 280. As shown in FIG. 19, the outer cover 300 has, by example only, an outer shape formed with a gently curved or arcuate outer sidewall 310, a contiguous upper wall 312 and an inner wall 314. An arm 316, is integrally formed with and depends from the top wall 312 within the interior of the cover 300 between the outer and inner sidewalls 310 and 312.

A clip 411 has a pair of outer spring arms 412 and 414 and an inner pair of spring jaws 416 and 418. The outer spring arms 412 and 414 snap within a spaced aperture along the base end cap 13 as shown in FIG. 19. The spring 416 and 418 receive one end of the arm 316 to releasably mount the outer cover 300 to the base 280.

The interconnection of the end 288 of the base 280 and the end 302 of the upper cover 300 forms an open ended recess which receives one end 20 or 22 of the fixed cross rail 18 which is secured to the joined base 280 and the upper cover 300 of the stanchion 13 by fasteners through the aligned bores 290 and 304.

A flange 292 is carried on one end of the lower base 280 as seem in FIG. 12. An aperture 294 is formed in the flange 292 and receives the shaft 77 of the drive member 76 therethrough as shown in FIG. 13. A bearing, such a NYLINER™ bearing 294, may be mounted in the aperture to support the drive shaft 76 in the flange 292.

According to another unique aspect of the present invention, removably attachable covers are provided for at least the side rails 12 and 14. The removable covers 400 and 402 for the side rails 12 and 14 may have substantial identical, mirror image shapes, and may be formed of any suitable material, such as metal, plastic, combinations thereof, etc. The interchangeable covers 400 and 402 allow a standard side rail 12, 14 to be used over and over again, with only the shape of the outer covers 400 and 402 and optionally, the outer covers of the end caps 13 and 15 to be revised from vehicle to vehicle or vehicle model to vehicle model. This significantly reduces the cost of the article carrier since common parts may be employed in large volumes and for a longer period of time.

As shown in FIGS. 17 and 20-23, the outer covers 400 and 402 have, by example only, an arcuate side wall 404, a lower end 406, and an upper end flange 408 with an angled edge 409. An arm 410 is fixed, or integrally formed, in the case of a plastic cover, on an inner surface of the outer cover 404 to a spaced location along the length of the cover 400 and 402. As shown in FIG. 17, the arm 410 depends between the side walls 404 of the outer covers 400 and 402. A rib 409 is integral between the rib 410 and the edge 409.

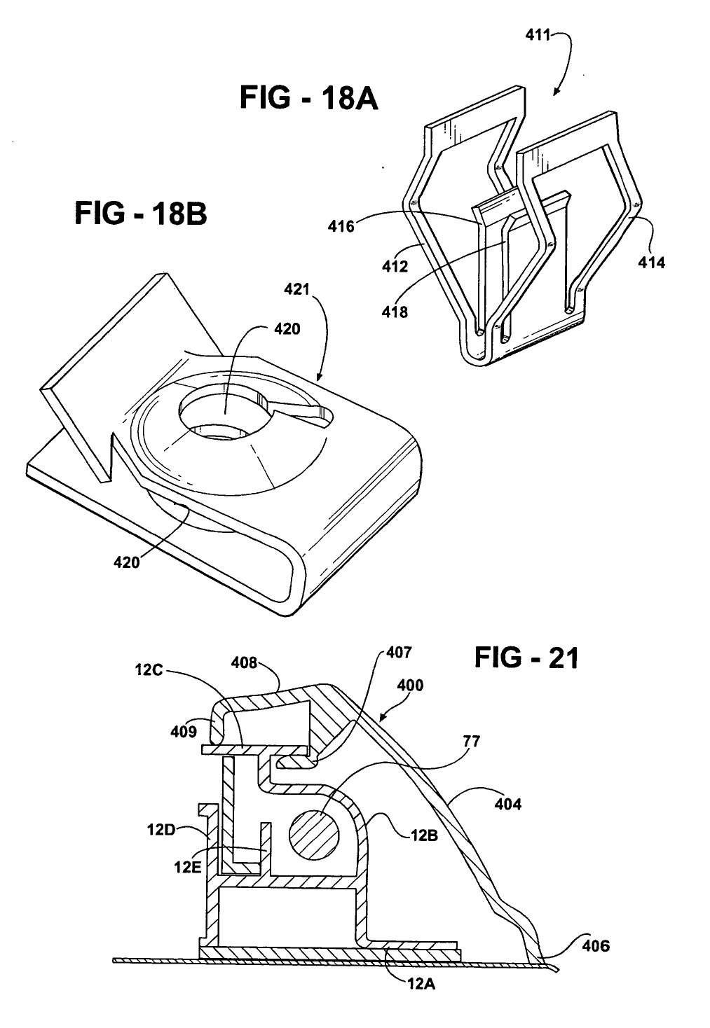

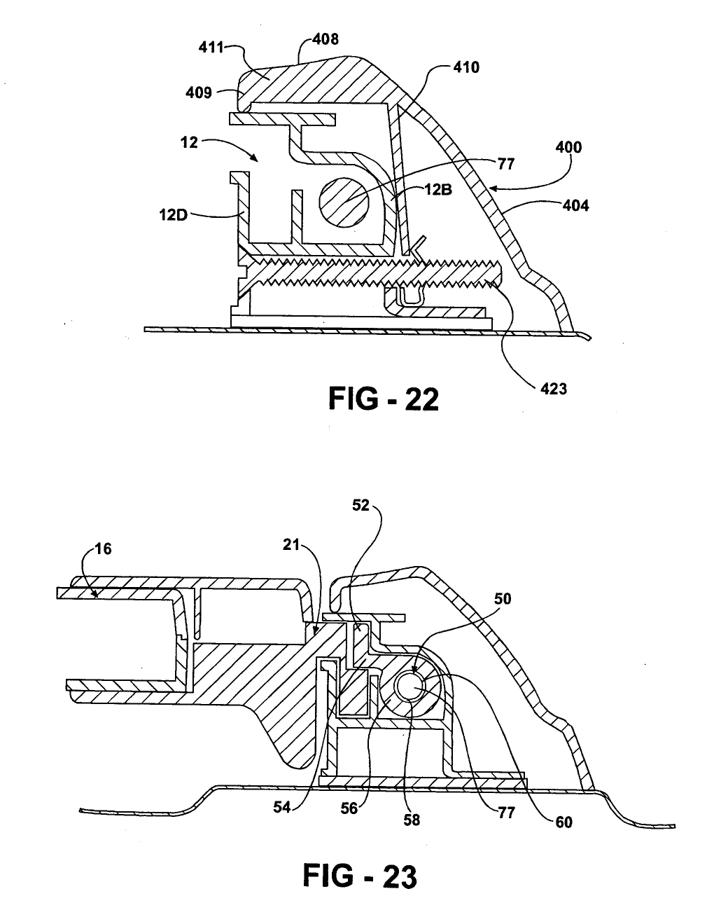

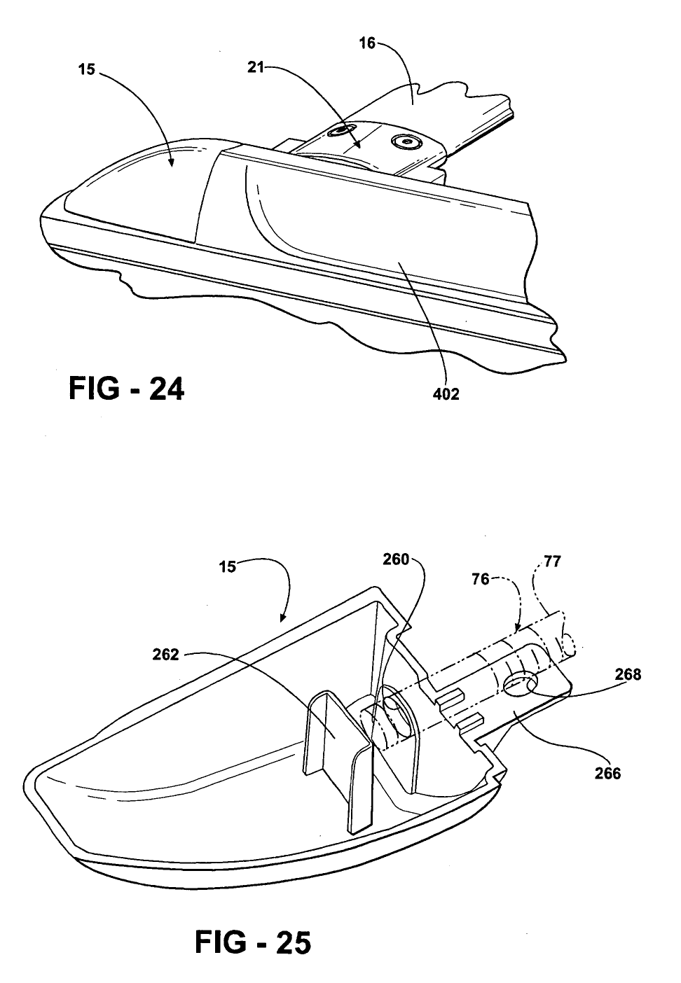

As shown in FIGS. 18B and 22, another mounting clip 421, having a generally U-shape formed of two spaced, spring legs, has an aperture 420 formed in each leg. The clip 421 is mounted over each of the spaced arms 410 and receives a fastener, such as a flat head screw 423 which is mountable through an aperture in the inner leg 12D of each side rail 12 and 14, an aligned aperture formed in the opposed leg 12B of the side rails 12 and 14, the aligned apertures 420 in the mounting clip 421 and the aperture 422 in each arm 410 to releasable attach the outer cover 400 to the side rail 12 or 14.

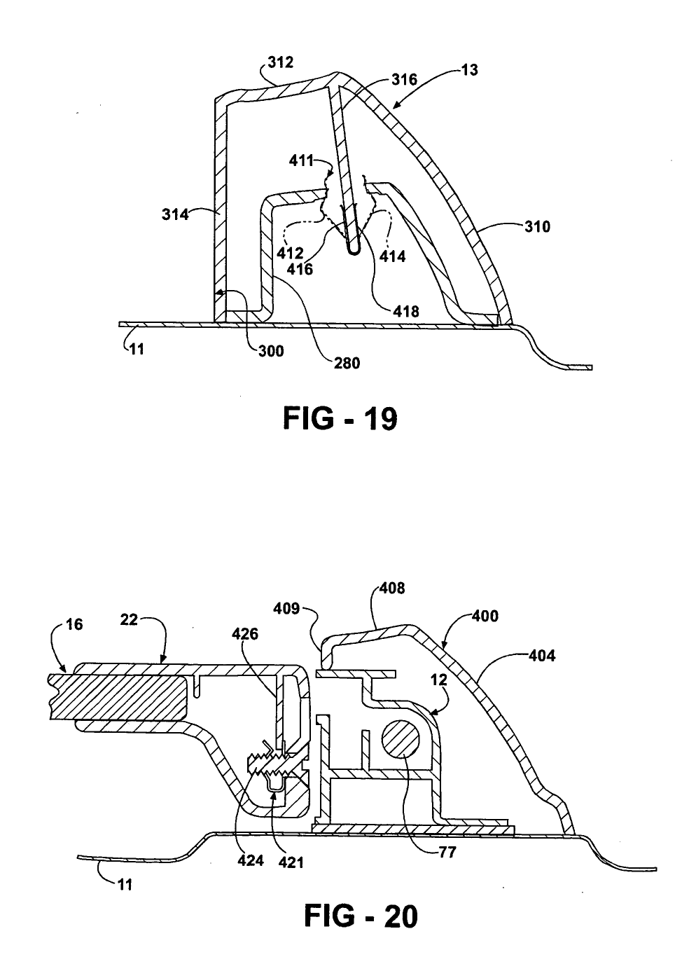

As shown in FIG. 20, the mounting clip 421 and a shorter fastener, such as a flat head screw or TORX™ flat head screw 424, are used to secure the opposed ends of the two part stanchion 22.

The mounting clip 421 engages an arm 426 depending from the upper stanchion part. The fastener 424 is threadingly extendable through the apertures 420 in the clip 421, an aperture in the arm 426 as well as an aperture in an end wall of the lower stanchion part to secure the two stanchion parts together.

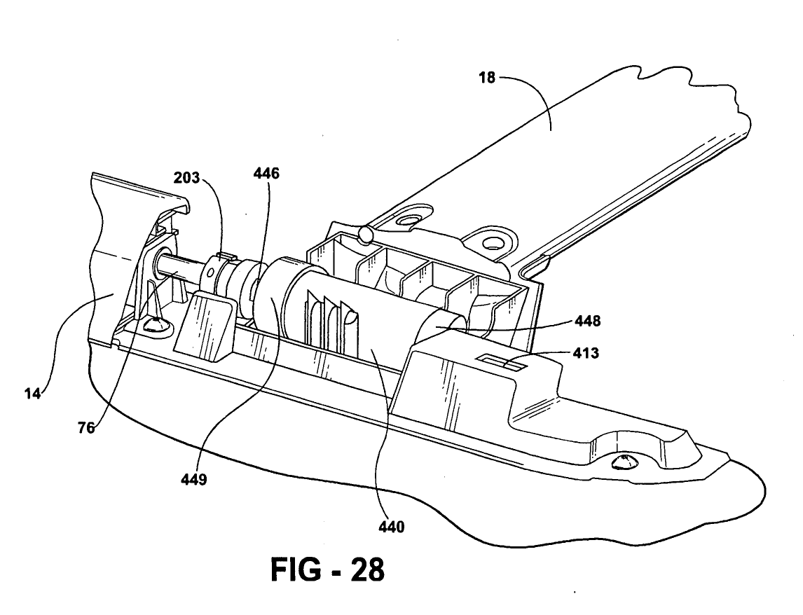

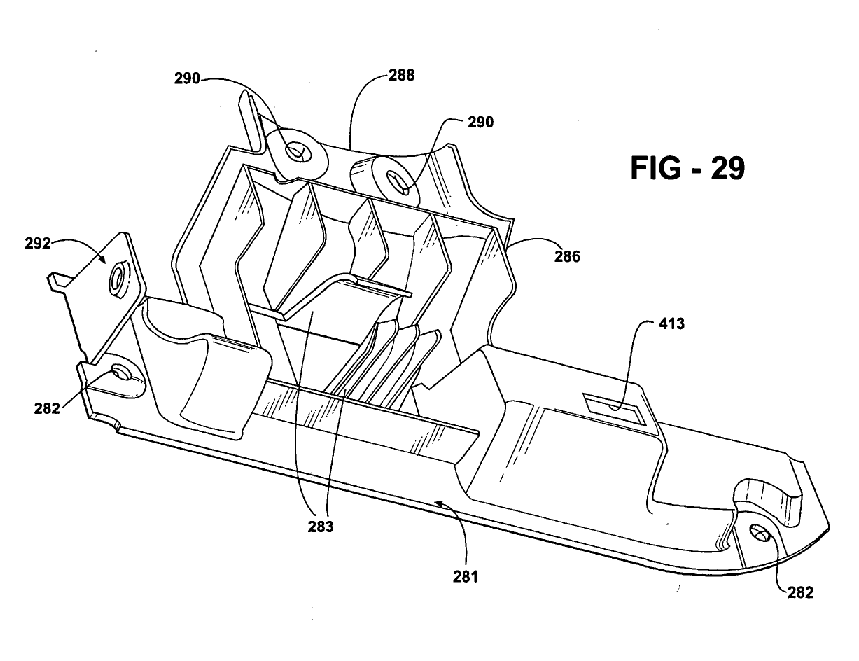

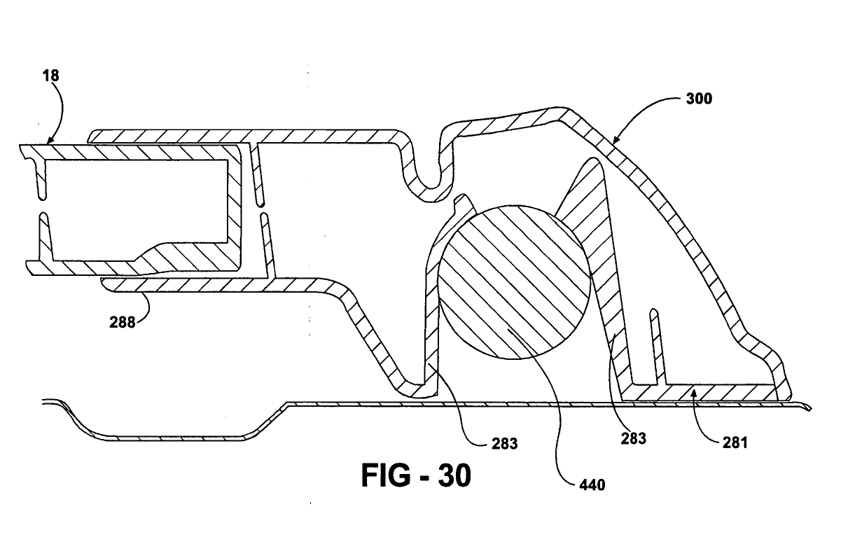

In another aspect of the present invention shown in FIGS. 28-30, the drive means still includes the drive members or rotatable shafts 76 rotatably mounted in each side rail 12 and 14. However, the flex shaft 112 or the central drive motor 100 are replaced by a pair of drive motors 440, only one of which is shown in FIG. 28. Each of the drive motors 440 are mounted on an end cap base 281 which is essentially the same as the end cap base 280 described above and shown in FIG. 12. The difference between the base 281 and the base 280 is a pair of support arms 283 formed in the base 281 for receiving the generally tubular shaped motor 440 instead of the cubical couplers 82 or 84. Otherwise, the base 281 is essentially the same as the base 280. The same upper cover 300 is mounted to the base 281 to complete the end cap 13.

An output shaft 446 extending from a gear transmission 449 on one end of the motor 440 is coupled through the connector 203 to the drive member 76 in the same manner described in previous aspects of the invention.

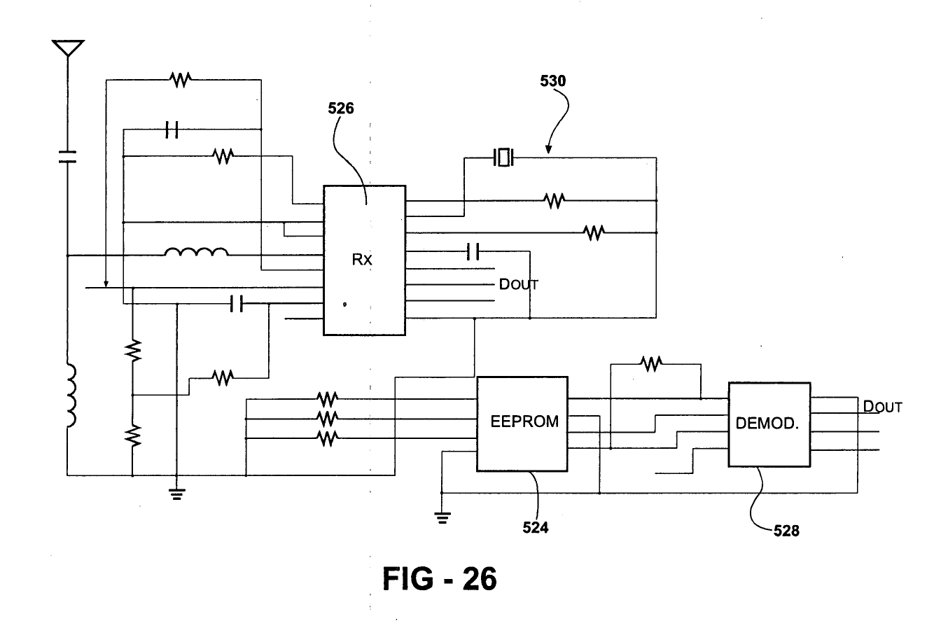

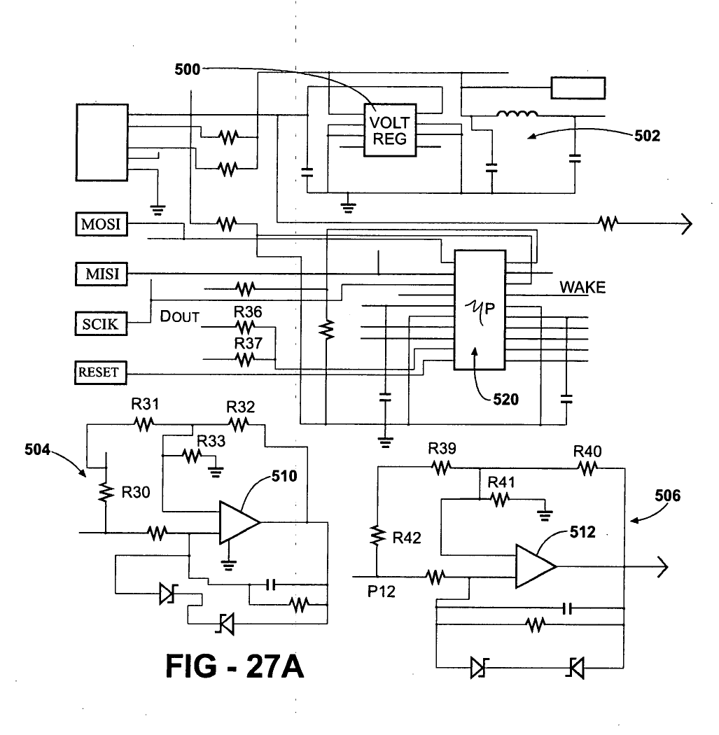

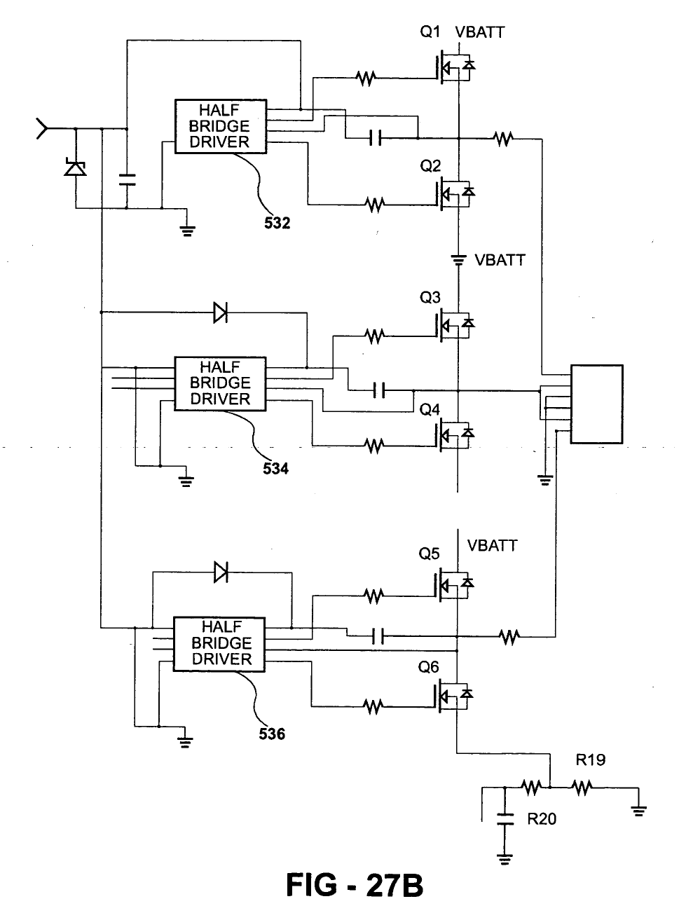

The motor control circuit shown in FIGS. 26, 27A and 27B controls each of the motors 440 mounted in the side rails 12 and 14. Encoders 448 unitarily mounted on each motor 440 provide rotational or angular position signals from which the rotational speed of each motor 440 can be determined. The control means receives the output signals of the encoders 448 on each of the motors 440 and provides appropriate control signals, such as pulse width modulated (PWM) or duty cycle regulation signals to the motors 440, so that the motors 440 rotate at the same rotational speed and at the same rotational amount when activated by the control switch as described above.

As shown in FIG. 27A, a voltage regulator 500 is connected to the vehicle electrical system and provides a regulated +5V power to the control means. A filter circuit 502 provides clean and decoupled +5V power to the control circuit.

The encoders 448 may be any type of encoder, such as a magnetic Hall effect encoder, an optical encoder, a magnetic inductive encoder or a mechanical switch (brush structure) encoder. Amplifying circuits 504 and 506 as shown in FIG. 27A accommodate each of these different types of encoders 448. In the circuits 504 and 506, op-amps 510 and 512, respectively, provide signal amplification. Resistors R30 and R42 provide sense bias for the magnetic Hall effect, optical or mechanical switch encoders 448. Zener diodes are used in place of the R30 and R42 resistors for a magnetic inductive encoder.

Hystersis is provided in the form of positive feedback for each op-amp 510 and 512. Positive feedback circuit for op-amp 510 is provided by resistors R31, R32 and R33. Positive feedback for op-amp 512 is provided by resistors R39, R40 and R41.

The output signals from each encoder 448 are applied at inputs P11 or P12 and are conditioned and buffered before being passed on to the control means as digital signals.

The control means is, by example only, formed of a microprocessor 520 which is again by example only, flash based and in-system programmable. I/O pins MOSI, MISI, SCIk and Reset for an SPI interface that permits programming or reprogramming of the controller 520 after assembly or during service.

In order to maintain low quiescent current consumption, microprocessor 520 periodically wakes up and turns on the Rf section using the FRSdn and Wake signals to determine if a signal is present from one of the encoders 448. If such an encoder signal is present, power is enabled for the duration of the signal transmission.

Referring briefly to FIG. 26, the integrated circuits 524, 526, and 528 and support components form an ISM band RF interface denoted generally by reference number 530 which permits remote control of the motors 440 by a key-fob commonly used in automobiles.

The circuit 526 is an integrated Rf-to-baseband receiver which includes clock generation, Rf PLL, and Automatic gain control. Data from the transmitter in the key fob is decoded by the receiver and output digitally at DOut.

The raw DOut signal is decoded by integrated circuit 528 which is a code hopping demodulator that determines whether the transmission is from the matched transmitter fob. If a match is detected, the command is then transmitted. A unique key encryption value is contained in the EEPROM circuit 524, along with other setup and control values.

The circuit 530 permits either the raw DOut or the processed DDat signal to be passed on to the microprocessor 520 through either resistors R36 or R37. In a low cost implementation where security is not important, the circuits 524 and 527 are omitted and resistor R36 is installed.

Referring now to FIG. 27B, pulse width modulation (PWM) motor drive is accomplished with three half bridge circuits associated with integrated circuits 532, 534 and 536. Each of these integrated circuits 532, 534 and 536 is a level shifting half bridge driver permitting operation of low cost N-channel MOSFET switches for both upper and lower drive elements.

Both motors 440 share a common half bridge driven by integrated circuit 534 and transistors Q3 and Q4 since both motors 440 are generally rotating in the same direction at the same time. The opposite pole of each motor 440 is driven by a separate driver (integrated circuit 532 and transistors Q1 and Q2 or integrated circuit 536 and transistors Q5 and Q6). These stages are each driven with a PWM duty cycle proportional to the command effort required to achieve the command track speed.

System current is monitored by a shunt resistor R19 shown in FIG. 27B. This value is fed to an analog-to-digital converter in the microprocessor 520 to assure that no malfunction or excessive load has been encountered.

The microprocessor 520 monitors the status of all signals and executes all control loops and algorithms. The microprocessor 520 has an internal clock oscillator that eliminates the need for an external crystal oscillator.

An important part of accurate position tracking is noting that the motors 440 continue to operate after current flow has been turned off. Monitoring these “coast down” encoder pulses after motor power is removed is necessary to provide accurate position tracking over time.

The microprocessor 520 also executes additional control functions. After the first installation, the position of the shuttle cleats 50 and the end of travel positions are unknown. An algorithm is executed by the microprocessor 520 to determine these positions and to zero all position counters. The algorithm can be re-executed after service. Current cleat 50 position and end of travel locations are stored in the memory. In order to reduce current consumption, these values are stored in a local EEPROM when the vehicle power is shut off.

Each motor 440 is controlled to achieve a constant target speed. Acceleration and deceleration are controlled for smooth, seamless operation. Speed control of both motors 440 is necessary to keep the instantaneous positions of the cleats 50 matched along the side rails 12 and 14.

Slight differences in operating speed of the two motors 440 will result in the accumulation of position errors. These errors are modeled and nulled periodically by skewing the start and stop times of each motor 440. The motors are re-zeroed whenever practical to the end of the side rails 12, 14.

At times, jamming will occur due to guide anomalies, such as bent, defective, snow clogged, etc., parts, untracked errors, or asymmetrical loads. In this case, the control means must execute the algorithm to determine which shuttle cleat 50 is stalled, and by manipulating the direction and speed of movement of each shuttle cleat 50, try to free the bound cleat 50.

It may also be desirable to eliminate pinch hazzards to modeling the applied power and the resulting speed of each shuttle cleat 50 to limit the hazzard to crushing cargo or other valuables.

Because several of the inventive articles carriers may be in a common area or in close proximity, encryption of key fob identification may be necessary to identify a single target vehicle.

Finally, in order to minimize battery current consumption, the microprocessor 520 disables most function during idle periods, waking itself and minimal other components in order to check for user commands.

In summary, there has been disclosed a unique article carrier for vehicles which maintains a movable cross rail substantially perpendicular to the side rails during longitudinal repositioning of the movable cross rail. In one aspect, the article carrier is provided with a unique powered drive means which automatically drives the movable cross rail to a desired longitudinal position with respect to the fixed cross rail when the drive means is activated. In another aspect, a manually operated hand crank is attachable to the coupling means in either side rail to enable manual repositioning of the cross rail from either side of the vehicle.

1. A vehicle article carrier comprising:
a pair of side rails adapted for spaced mounting relative to a vehicle body surface;
a movable cross rail slidably disposed on and movably positionable along the side rails;
a rotatable shaft disposed in each side rail;
means, coupled to each rotatable shaft and connected to one end of the cross rail, for converting rotation of the rotatable shafts to translation of the movable cross rail along the side rails; and
cover means affixed to each side rail, for covering each side rail.

2. The vehicle article carrier of claim 1 wherein the converting means comprises:
a cleat movably mounted in each side rail; and
means, carried on the cleat, for coupling the cleat to the rotatable shaft in each side rail for longitudinal movement of the cleat upon rotation of each rotatable shaft.

3. The vehicle article carrier of claim 2 wherein the converting means comprises:
a tubular portion carried on the cleat and having an internally threaded bore means; and
each rotatable shaft having threads engagable with the threaded bore means.

4. The vehicle article carrier of claim 2 wherein:
each rotatable shaft is threaded; and
the coupling means includes means for threadingly coupling the cleat to the rotatable shaft.

5. The vehicle article carrier of claim 4 wherein the means for threadingly coupling comprises:
a tubular member carried on the cleat; and
a threaded metallic insert mounted in the tubular member, the threaded metallic insert threadingly engagable with the threaded rotatable shaft.

6. The vehicle article carrier of claim 2 further comprising:
an electric motor having a bi-directionally rotatable, oppositely extending output shafts; and
means for coupling the motor output shafts to the rotatable shafts.

7. The vehicle article carrier of claim 1 comprising:
a fixed cross rail stationarily mounted on the pair of side rails;
an electric motor mounted in the fixed cross rail, the electric motor having two oppositely extending, bi-directionally rotatable output shafts; and
the coupling means connected at one end to one output shaft of the motor and coupled to one rotatable shaft for transmitting rotation of the motor output shafts to rotation of the rotatable shafts.

8. The vehicle article carrier of claim 1 wherein the coupler means further comprises:
a first and a second coupling means, each coupled to one of the rotatable shafts in the pair of side rails;
a rotatable cross shaft coupled to the first and second coupling means; and
means for rotating the cross shaft to effect simultaneous rotation of the rotatable shafts in each of the side rails.

9. The vehicle article carrier of claim 8 wherein each of the first and second coupling means comprise:
a first shaft operably coupled to the cross shaft;
a second shaft operably coupled to one of the rotatable shafts in one of the side rails; and
means for coupling the first and second shafts for simultaneous rotation.

10. The vehicle article carrier of claim 9 wherein each of the first and second coupling means further comprises:
a shaft end extending from the second shaft; and
a hand crank attachable to the shaft end to effect manual rotation of the cross shaft and the rotatable shafts by the first and second shafts.

11. The vehicle article carrier of claim 8 further comprising:
the cross shaft including first and second cross shafts; and
motor means, coupled to the first and second cross shafts, for rotating the first and second cross shafts.

12. The vehicle article carrier of claim 1 1 wherein first and second cross shafts, are connected at one end to the motor means and at another end to one of the first and second coupling means.

13. The vehicle article carrier of claim 8 wherein:
the cross shaft comprises a flexible cross shaft.

14. The vehicle article carrier of claim 8 further comprising:
a first pair of end caps attached to one end of the side rails.

15. The vehicle article carrier of claim 14 further comprising:
a first pair of end caps fixedly supporting a non-movable cross rail.

16. The vehicle article carrier of claim 14 further comprising:
the first pair of end caps including an outer cover complementary to the cover means on the side rails.

17. The vehicle article carrier of claim 1 further comprising:
a second pair of end caps affixed to an opposite end of the side rails.

18. The vehicle article carrier of claim 17 wherein:
each of the second pair of end caps includes means for rotatably supporting the rotatable shaft extending through the side rails.

19. The vehicle article carrier of claim 17 wherein the second pair of end caps further comprises:
an outer cover complementary to the cover means on the side rails.

20. The vehicle article carrier of claim 1 further comprising:
the first pair of end caps disposed adjacent one end of the side rails; and
drive means, mounted in each of the first pair of end caps and coupled to the rotatable shaft in one of the side rails, for rotating each rotatable shaft.

21. The vehicle article carrier of claim 20 wherein the drive means comprises:
a electric motor having a bi-directional rotatable output shaft.

22. A vehicle article carrier comprising:
a pair of side rails adapted for spaced mounting relative to a vehicle body surface;
a rotatable shaft disposed in each side rail;
a movable cross rail slidably disposed on and movably positionable along the side rails;
means, coupled to each rotatable shaft and one end of the movable cross rail, for converting rotation of the rotatable shafts to translation of the movable cross rail along the side rails;
a first and a second coupling means, each coupled to one of the rotatable shafts in the pair of side rails; and
rotatable cross shaft means coupled between the first and second coupling means, for effecting simultaneous rotation of the rotatable shafts in each of the side rails upon rotation of the cross shaft.

23. The vehicle article carrier of claim 22 wherein the converting means comprises:
a cleat movably mounted in each side rail; and
means, carried on the cleat, for coupling the cleat to the rotatable shaft in each side rail for longitudinal movement of the cleat upon rotation of each rotatable shaft.

24. The vehicle article carrier of claim 23 wherein the converting means comprises:
a tubular portion carried on the cleat and having an internally threaded bore means; and
each rotatable shaft having threads engagable with the threaded bore means.

25. The vehicle article carrier of claim 23 wherein:
each rotatable shaft is threaded; and
the coupling means includes means for threadingly coupling the cleat to the rotatable shaft.

26. The vehicle article carrier of claim 25 wherein the means for threadingly coupling comprises:
a tubular member carried on the cleat; and
a threaded metallic insert mounted in the tubular member, the threaded metallic insert threadingly engagable with the threaded rotatable shaft.

27. The vehicle article carrier of claim 22 further comprising:
an electric motor having a bi-directionally rotatable, oppositely extending output shafts; and
means for coupling the motor output shafts to the cross shaft.

28. The vehicle article carrier of claim 22 comprising:
a fixed cross rail stationarily mounted on the pair of side rails;
the rotatable cross shaft disposed in the fixed cross rail and including first and second cross shaft portions;
an electric motor mounted in the fixed cross rail, the electric motor having two oppositely extending, bi-directionally rotatable output shafts; and
the first and second cross shaft portions, each connected at one end to one output shaft of the motor and coupled at another end to the first and second coupling means for transmitting rotation of the motor output shafts to rotation of the rotatable shafts.

29. The vehicle article carrier of claim 22 wherein each of the first and second coupling means comprise:
a first shaft operably coupled to the cross shaft;
a second shaft operably coupled to one of the rotatable shafts in one of the side rails; and
means for coupling the first and second shafts for simultaneous rotation.

30. The vehicle article carrier of claim 29 wherein:
the rotatable cross shaft means includes a flexible shaft coupled to the first and second coupling means; and
a hand crank attachable to one of the first and second coupling means to effect manual rotation of the cross shaft and the rotatable shafts.

31. The vehicle article carrier of claim 22 wherein the cross shaft comprises a flexible cross shaft.

32. The vehicle article carrier of claim 22 further comprising:
a first pair of end caps attached to one end of the side rails.

33. The vehicle article carrier of claim 32 further comprising:
a first pair of end caps fixedly supporting a non-movable cross rail.

34. The vehicle article carrier of claim 33 further comprising:
a second pair of end caps affixed to an opposite end of the side rails.

35. The vehicle article carrier of claim 34 wherein:
each of the second pair of end caps includes means for rotatably supporting the rotatable shaft extending through the side rails.

36. The vehicle article carrier of claim 21 further comprising:
means, coupled to the output shaft of each of the motors for generating output shaft rotation related signals; and
control means, responsive to the signals from the encoder means, for generating control signals to both of the motors to control the speed of rotation of the output shafts of both motors.

37. The vehicle article carrier of claim 36 wherein:
the control means controls the speed of rotation of the outputs shafts of the motors at substantially identical speeds.

38. The vehicle article carrier of claim 36 wherein the control means further comprises:
wireless communication receiver means, responsive to wireless activation signals for activating motor operation.

39. The vehicle article carrier of claim 38 further comprising:
a portable wireless communication transmitter means for transmitting motor activation signals to the control means.

40. The vehicle article carrier of claim 21 further comprising:
a memory, coupled to the control means, for storing end of travel position limits of the means for converting rotation; and
means for determining the start position of the means for converting rotation.
